(19) United States
(12) Patent Application Publication
(10) Pub. No.: US 2026/0208566 A1
(43) Pub. Date: Jul. 23, 2026

(54) VEHICLE WINDOW GLASS

(71) Applicant: AGC Inc., Tokyo (JP)

(72) Inventors: Atsutoshi NAKATA, Tokyo (JP); Eita UMEZAWA, Tokyo (JP); Akio MAMURO, Tokyo (JP)

(73) Assignee: AGC Inc., Tokyo (JP)

(21) Appl. No.: 19/450,480

(22) Filed: Jan. 15, 2026

(30) Foreign Application Priority Data
Jan. 23, 2025 (JP) 2025-009622

(51) Int. Cl. B60J 1/00; H01Q 1/12; H01Q 7/00

(52) U.S. Cl. CPC B60J 1/002; H01Q 1/1278; H01Q 7/00

(57) ABSTRACT

A vehicle window glass of the present invention includes a glass plate, an antenna, and a defogger. The antenna includes a first antenna provided on one side in a horizontal direction, and a second antenna provided on the other side in the horizontal direction. Each of the first antenna and the second antenna includes a feeding portion, a first vertical element, a first horizontal element, and a second vertical element. The first vertical element extends from the feeding portion to one side in a vertical direction close to the defogger. The first horizontal element extends from the first vertical element to a side in the horizontal direction in which the first antenna and the second antenna are close to each other. The second vertical element extends from the first horizontal element to the other side in the vertical direction.

### CROSS-REFERENCE TO RELATED APPLICATION

This application claims priority from Japanese Patent Application No. 2025-009622, filed Jan. 23, 2025, the content of which is incorporated herein by reference in their entirety.

### BACKGROUND OF THE INVENTION

### Field of the Invention

The present invention relates to a vehicle window glass.

### Description of Related Art

Automobiles in recent years have had window glass on which an antenna is formed. This antenna can receive radio waves in various frequency bands such as AM broadcast waves, FM broadcast waves, digital audio broadcasting (DAB) Band III of the European standard, and terrestrial digital broadcast waves.

An antenna formed in an opening of the window glass in this way has a pattern formed to obtain a predetermined reception sensitivity according to an area of the opening of the window glass. For example, a defogger having an electric heating wire for heating a glass is disposed on a rear glass of an automobile for anti-fogging and anti-icing purposes. In a region of the opening that is different from the defogger region, an antenna pattern is formed to obtain a predetermined sensitivity for radio waves in a predetermined frequency band.

Japanese Unexamined Patent Application, First Publication No. 2012-248981 (hereinafter, referred to as Patent Document 1) below discloses a vehicle glass antenna provided with a diversity antenna for receiving FM broadcast waves.

In Patent Document 1, in order to exert the effectiveness of the diversity antenna, it is preferable that a transmission characteristic from a first antenna to a second antenna be excellent. However, if a diversity antenna is provided at a position of the glass on which a defogger is provided, a region available for disposing the diversity antenna is limited due to space constraints. In this case, there have been cases in which a reception gain in a predetermined frequency band and the transmission characteristic from the first antenna to the second antenna cannot be improved.

### SUMMARY OF THE INVENTION

The present invention provides a vehicle window glass capable of receiving radio waves in a predetermined frequency band with a desired gain and achieving an improved transmission characteristic from a first antenna to a second antenna by employing a pattern different from that of conventional diversity antennas formed on glass plates.

In order to solve the above-described problem, the present invention has the following configuration.

A vehicle window glass according to one aspect of the present invention includes a glass plate, an antenna provided on the glass plate, the antenna being capable of receiving radio waves in a predetermined frequency band, and an electric heating defogger provided on the glass plate. When a direction parallel to a horizontal plane is defined as a horizontal direction, and a direction perpendicular to the horizontal direction is defined as a vertical direction in a plan view in a state in which the glass plate is attached to a window frame, the antenna includes a first antenna provided on one side in the horizontal direction, and a second antenna provided on the other side in the horizontal direction. Each of the first antenna and the second antenna includes a feeding portion, a first vertical element extending from the feeding portion to one side in the vertical direction close to the defogger, a first horizontal element close to the defogger in the vertical direction, the first horizontal element extending from the first vertical element to a side in the horizontal direction in which the first antenna and the second antenna are close to each other, and a second vertical element extending from the first horizontal element to the other side in the vertical direction, the second vertical element of the first antenna and the second vertical element of the second antenna being close to the other in the horizontal direction.

In the vehicle window glass according to one aspect of the present invention, the second vertical element of the first antenna and the second vertical element of the second antenna may be close to each other in the horizontal direction with a spacing of 10 mm or less.

In the vehicle window glass according to one aspect of the present invention, the first horizontal element and the defogger may be close to each other in the vertical direction with a spacing of 30 mm or less.

In the vehicle window glass according to one aspect of the present invention, each of the first antenna and the second antenna may include a first loop element. The first loop element is connected to the first vertical element. The first loop element has a loop shape. The first loop element is provided on a side in the horizontal direction in which the first antenna and the second antenna are away from the other.

In the vehicle window glass according to one aspect of the present invention, each of the first antenna and the second antenna may include a second loop element. The second loop element is connected to the first vertical element. The second loop element has a loop shape. The second loop element is provided on a side in the horizontal direction in which the first antenna and the second antenna are close to each other.

A vehicle window glass according to one aspect of the present invention includes a glass plate, an antenna provided on the glass plate, the antenna being capable of receiving radio waves in a predetermined frequency band, and an electric heating defogger provided on the glass plate. When a direction parallel to a horizontal plane is defined as a horizontal direction, and a direction perpendicular to the horizontal direction is defined as a vertical direction in a plan view in a state in which the glass plate is attached to a window frame, the antenna includes a first antenna provided on one side in the horizontal direction, and a second antenna provided on the other side in the horizontal direction. Each of the first antenna and the second antenna includes a feeding portion, a first vertical element extending from the feeding portion to one side in the vertical direction close to the defogger, and the first vertical element of the first antenna and the first vertical element of the second antenna are connected to each other by a connection element. The connection element is close to the defogger in the vertical direction. The connection element extends in the horizontal direction.

In the vehicle window glass according to one aspect of the present invention, the connection element and the defogger may be close to each other in the vertical direction with a spacing of 30 mm or less.

In the vehicle window glass according to one aspect of the present invention, each of the first antenna and the second antenna may include a first loop element. The first loop element is connected to the first vertical element. The first loop element has a loop shape. The first loop element is provided on a side in the horizontal direction in which the first antenna and the second antenna are away from the other.

In the vehicle window glass according to one aspect of the present invention, each of the first antenna and the second antenna may include a second loop element. The second loop element is connected to the first vertical element. The second loop element has a loop shape. The second loop element is provided on a side in the horizontal direction in which the first antenna and the second antenna are close to each other.

In the vehicle window glass according to one aspect of the present invention, the antenna may be capable of receiving FM broadcast radio waves as the radio waves in the predetermined frequency band.

According to the present invention, it is possible to receive radio waves in a predetermined frequency band with a desired gain and achieve an improved transmission characteristic from a first antenna to a second antenna by employing a pattern different from that of conventional diversity antennas formed on glass plates.

### BRIEF DESCRIPTION OF THE DRAWINGS

FIG. 1 is a plan view showing a vehicle window glass according to a first embodiment of the present invention.

FIG. 2 is a plan view showing a vehicle window glass according to a second embodiment of the present invention.

FIG. 3 is a plan view showing a vehicle window glass according to a third embodiment of the present invention.

FIG. 4 is a plan view showing a vehicle window glass according to a fourth embodiment of the present invention.

FIG. 5 is a graph showing measurement results of an antenna gain in a predetermined frequency band of a vehicle window glass according to a first example of the present invention.

FIG. 6 is a graph showing measurement results of a reflection characteristic (S11) in the predetermined frequency band of the vehicle window glass according to the first example of the present invention.

FIG. 7 is a graph showing measurement results of a transmission characteristic (S21) in the predetermined frequency band of the vehicle window glass according to the first example of the present invention.

FIG. 8 is a graph showing measurement results of an antenna gain in a predetermined frequency band of a vehicle window glass according to a second example of the present invention.

FIG. 9 is a graph showing measurement results of a reflection characteristic (S11) in the predetermined frequency band of the vehicle window glass according to the second example of the present invention.

FIG. 10 is a graph showing measurement results of a transmission characteristic (S21) in the predetermined frequency band of the vehicle window glass according to the second example of the present invention.

### DETAILED DESCRIPTION OF THE INVENTION

Hereinafter, a vehicle window glass according to an embodiment of the present invention will be described in detail with reference to the drawings. Note that, for ease of understanding, scales of each of portions in the drawings may be different from actual ones. In directions such as parallel, perpendicular, orthogonal, horizontal, vertical, upward and downward, and leftward and rightward, a deviation to an extent that effects of the embodiment are not impaired is allowed. A shape of a corner is not limited to a right angle and may be arcuately rounded. Parallel, perpendicular, orthogonal, horizontal, and vertical may include substantially parallel, substantially perpendicular, substantially orthogonal, substantially horizontal, and substantially vertical. Particularly, although a shape of an antenna element to be described later is shown as a straight line in the drawings, it is not limited to a straight line and may be curved in an arcuate shape.

Also, hereinafter, in a plan view with the vehicle window glass attached to a window frame, a direction parallel to a horizontal plane is defined as a horizontal direction, and a direction orthogonal to the horizontal direction is defined as a vertical direction. Also, the horizontal direction and the vertical direction each have two opposing orientations, and when indicating one of the two opposing orientations, they are defined as a first direction, a second direction, a third direction, and a fourth direction. Note that, a relationship between the horizontal direction and the vertical direction, and the first direction, the second direction, the third direction, and the fourth direction is defined in each embodiment. Also, “to” indicating a numerical range means that numerical values stated before and after “to” are included as a lower limit value and an upper limit value.

Also, in description of each component of the antenna (such as a feeding portion or an antenna element), when the term “connection” is simply used, it means both physical and electrical connection. Particularly, when the phrase “electrically connected” is used, it only needs to be at least electrical connection and does not require a physical connection. For example, when an element A and an element B are “electrically connected”, an element C that physically and electrically connects element A and element B may be interposed. That is, when the phrase “electrically connected” is used, the element A and the element B do not need to be physically connected directly.

Furthermore, in the following description, an example in which the vehicle window glass according to the embodiment of the present invention is applied to a rear glass at a rear part of a vehicle will be described. As long as the vehicle window glass is provided with a defogger, the vehicle window glass according to the embodiment of the present invention can be applied to glass other than the rear glass.

### First Embodiment

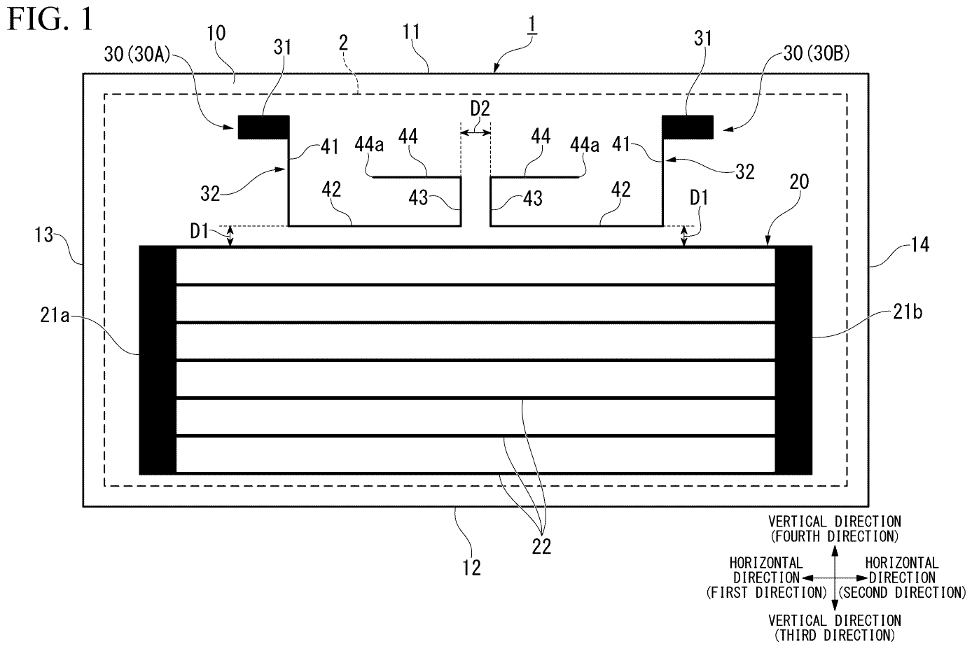

FIG. 1 is a plan view showing a vehicle window glass 1 according to a first embodiment of the present invention. The vehicle window glass 1 shown in FIG. 1 is attached to a window frame 2 at a rear part of a vehicle body. Note that, in FIG. 1, an opening of the window frame 2 is indicated by a dotted line. Also, in FIG. 1, the vehicle window glass 1 in a state of being attached to the window frame 2 is shown as viewed from the inside of the vehicle (a view from inside the vehicle). In FIG. 1, on an outer side of the opening indicated by the dotted line, a circumferential edge portion of a main surface of a glass plate 10 and the window frame 2 which is a flange serving as a metal portion are attached to each other with an adhesive such as a urethane resin (not shown in the drawings). Note that, the glass plate 10 may have a light-shielding layer of a predetermined width formed on a circumferential edge portion of a surface on a vehicle interior side, the light-shielding layer being formed of a color ceramic layer in black, a dark color, or other colors such as white, a color ink layer printed with an organic ink, an inorganic ink, or the like. The glass plate 10 is attached to the window frame 2 by an adhesive applied to the light-shielding layer. Note that, when the light-shielding layer is a color ceramic layer, the light-shielding layer is formed by printing a ceramic paste containing glass frit and a black or dark color pigment by screen printing or the like, and then firing the printed ceramic paste.

As shown in FIG. 1, the vehicle window glass 1 of the present embodiment includes the glass plate 10, a defogger 20, and an antenna 30. The defogger 20 and the antenna 30 are formed by, for example, printing and firing a silver paste containing silver powder and glass frit on a surface on the vehicle interior side of the glass plate 10. However, the antenna 30 may be formed of a conductive material such as copper on a transparent resin film and may be attached to a surface on the vehicle interior side of the glass plate 10. The glass plate 10 has a substantially quadrangular outer shape in a plan view. When the glass plate 10 is attached to the window frame 2, an outer edge of the glass plate 10 includes an upper edge 11 and a lower edge 12 facing each other in the vertical direction and a left edge 13 and a right edge 14 facing each other in the horizontal direction.

The vehicle window glass 1 is manufactured by printing a ceramic paste on the glass plate 10 and drying it to form a color ceramic paste coating film, and then printing a silver paste and drying it to form a silver paste coating film. Thereafter, the glass plate 10 may be heated to 600 to 700° C. to fire the color ceramic paste coating film and the silver paste coating film, thereby forming the light-shielding layer, the defogger 20, and the antenna 30. During heating of the glass plate 10, the glass plate 10 may be bent and formed into a predetermined shape. As a method for bending and forming, a known method such as press forming and gravity forming can be used. Also, if the glass plate 10 is a rear glass, the glass plate 10 may be heated to 600 to 700° C. and then rapidly cooled to 300° C. or lower to form tempered glass.

The defogger 20 has a conductive pattern provided on the glass plate 10. The defogger 20 shown in FIG. 1 is a defogger of an electric-heating type defogger. The defogger 20 includes a first bus bar 21a, a second bus bar 21b, and a plurality of heater wires 22. The first bus bar 21a and the second bus bar 21b are a pair of bus bars that extend in the vertical direction. The plurality of heater wires 22 are disposed between the first bus bar 21a and the second bus bar 21b. The plurality of heater wires 22 extend in the horizontal direction. Note that, the defogger 20 may include a short-circuit wire (not shown in the drawings) that extends in the vertical direction and short-circuits at least a part of the plurality of heater wires 22.

The heater wires 22 are disposed between the first bus bar 21a and the second bus bar 21b. A voltage (DC voltage) is applied to the heater wires 22 via the first bus bar 21a and the second bus bar 21b. Therefore, the heater wires 22 heat the glass plate 10. When the glass plate 10 is heated, condensation (fogging) on the glass plate 10 is removed.

The first bus bar 21a and the second bus bar 21b are disposed at both end sides of the glass plate 10 in the horizontal direction. The first bus bar 21a extends in the vertical direction along the left edge 13 of the glass plate 10. The second bus bar 21b extends in the vertical direction along the right edge 14 of the glass plate 10. The first bus bar 21a and the second bus bar 21b supply power to the plurality of heater wires 22 extending in the horizontal direction to run parallel to each other. The number of the heater wires 22 is not particularly limited. Note that, it is preferable that the first bus bar 21a and the second bus bar 21b be formed on the light-shielding layer.

The antenna 30 is configured to be capable of receiving radio waves in a predetermined frequency band. That is, the antenna 30 resonates at a frequency in the predetermined frequency band. The antenna 30 may be configured to be capable of receiving radio waves in two different frequency bands. The two different frequency bands may be a combination of frequency bands that partially overlap, or may be a combination of frequency bands that do not overlap at all. For example, the antenna 30 is capable of receiving radio waves of a VHF band (30 MHz to 300 MHz).

The antenna 30 of the present embodiment receives, as the radio waves in the VHF band, radio waves of, for example, FM broadcast waves (76 MHz to 108 MHz). Furthermore, the antenna 30 of the present embodiment receives, as the radio waves in the VHF band, radio waves of, for example, Band III (174 MHz to 240 MHz) of the DAB standard. Note that, the antenna 30 may receive radio waves in DTV waves (470 MHz to 710 MHz) as a UHF band (300 MHz to 3 GHz), radio waves in AM broadcast waves (522 kHz to 1710 kHz) as an MF band, or the like.

The antenna 30 is a glass antenna provided on the glass plate 10. The antenna 30 is disposed in a region above the defogger 20 when the glass plate 10 is attached to the window frame 2. However, a disposition of the antenna 30 is not limited to the region above the defogger 20, and it may be disposed in a region below the defogger 20. The antenna 30 includes a feeding portion 31 and an antenna element 32 electrically connected to the feeding portion 31.

The antenna 30 shown in FIG. 1 is a diversity antenna. The antenna 30 includes a first antenna 30A disposed on a left side (one side in the horizontal direction) and a second antenna 30B disposed on a right side (the other side in the horizontal direction) in the region above the defogger 20 of the glass plate 10. The first antenna 30A and the second antenna 30B have a left-right symmetrical structure. Therefore, in the following description, a structure of the first antenna 30A (main antenna) will be described. Since description of a structure of the second antenna 30B (sub-antenna) overlaps description of the first antenna 30A, description thereof will be simplified or omitted. Note that, the structures of the first antenna 30A and the second antenna 30B need not be completely left-right symmetrical.

In the following, a leftward horizontal direction is defined as a first direction, a rightward horizontal direction as a second direction, a downward vertical direction as a third direction, and an upward vertical direction as a fourth direction. Note that, the definitions of the first direction, the second direction, the third direction, and the fourth direction correspond to the first antenna 30A. In definition of directions for the second antenna 30B, the definitions of the first direction and the second direction are reversed.

Also, the first direction has an absolute value of an angle θ1 with respect to the horizontal direction, which may include 0°≤θ1≤15°, may be in a range of 0°≤θ1≤10°, may be in a range of 0°≤θ1≤5° may be in a range of 0°≤θ1≤3°, or may be 01=0°. When the angle θ1 at which the first direction extends approaches to 0°, a design appearance of the antenna 30 is improved. The second direction also is similarly defined.

The third direction has an absolute value of an angle θ2 with respect to the vertical direction, which may include 0°≤θ2≤15°, may be in a range of 0°≤θ2≤10°, may be in a range of 0°≤θ2≤5°, may be in a range of 0°≤θ2≤3°, or may be θ2=0°. When the angle θ2 at which the third direction extends approaches to 0°, the design appearance of the antenna 30 is improved. The fourth direction also is similarly defined.

The feeding portion 31 has, for example, a conductor pattern formed in a rectangular shape. The feeding portion 31 is electrically connected to one end of a power feed line (not shown in the drawings). Note that, a shape of the feeding portion 31 may be other shapes such as a circular shape or other polygonal shapes. In FIG. 1, the feeding portion 31 of the first antenna 30A is disposed at a position close to the upper edge 11 on the left edge 13 side of the glass plate 10.

The antenna element 32 includes a first vertical element 41, a first horizontal element 42, a second vertical element 43, and a second horizontal element 44. The first vertical element 41 is connected to the feeding portion 31. Note that, the first vertical element 41 may be electrically connected to the feeding portion 31 via, for example, an element (not shown in the drawings) that extends in the horizontal direction from the feeding portion 31. The first vertical element 41 has a linear conductor pattern extending in the third direction from the feeding portion 31.

The first horizontal element 42 has a linear conductor pattern extending in the horizontal direction from the first vertical element 41. The first horizontal element 42 of the first antenna 30A extends in the second direction from an end part of the first vertical element 41 in the third direction toward the second antenna 30B. A spacing of dimension D1 is formed in the vertical direction between the first horizontal element 42 and the defogger 20 (uppermost heater wire 22).

The dimension D1 is, for example, 100 mm or less. The dimension D1 is preferably 30 mm or less, may be 10 mm or less, or may be 5 mm or less. A lower limit of the dimension D1 is not particularly limited as long as it is greater than 0 mm. If the first horizontal element 42 and the defogger 20 are capacitively coupled, and a function as an improvement element for a transmission characteristic (S21) and a reflection characteristic (S11) in the predetermined frequency band can be obtained, the lower limit of the dimension D1 is set as appropriate. Note that, a length over which each of the first horizontal element 42 of the first antenna 30A and the first horizontal element 42 of the second antenna 30B is close to the defogger 20 (the uppermost heater wire 22) is preferably 5 mm or more and less than 40 mm. Also, a length over which the first horizontal element 42 of the first antenna 30A is close to the defogger 20 may be the same as a length over which the first horizontal element 42 of the second antenna 30B is close to the defogger 20. These lengths may differ from each other as long as they fall within the above-described range of lengths over which the horizontal elements are close to the defogger 20.

The second vertical element 43 has a linear conductor pattern extending in the fourth direction from an end part of the first horizontal element 42 in the second direction. The second vertical element 43 has a length of one-third to two-thirds that of the first vertical element 41. A spacing of dimension D2 is formed in the horizontal direction between the second vertical element 43 of the first antenna 30A and the second vertical element 43 of the second antenna 30B.

The dimension D2 is, for example, 90 mm or less. The dimension D2 is preferably 10 mm or less, may be 5 mm or less, or may be 3 mm or less. A lower limit of the dimension D2 is not particularly limited as long as it is greater than 0 mm. If the second vertical element 43 of the first antenna 30A and the second vertical element 43 of the second antenna 30B are capacitively coupled, and a function as an improvement element for the transmission characteristic (S21) and the reflection characteristic (S11) in the predetermined frequency band can be obtained, the lower limit of the dimension D2 is set as appropriate. Note that, a length over which the second vertical element 43 of the first antenna 30A and the second vertical element 43 of the second antenna 30B are close to each other is preferably 30 mm or more and 100 mm or less. Also, the second vertical element 43 of the first antenna 30A and the second vertical element 43 of the second antenna 30B may have the same length. These lengths may differ from each other as long as they fall within the above-described range of lengths over which the vertical elements are close to each other.

The second horizontal element 44 has a linear conductor pattern extending in the first direction from an end part of the second vertical element 43 in the fourth direction. An end part of the second horizontal element 44 in the first direction is disposed with a spacing in the horizontal direction with respect to the first vertical element 41. That is, the end part of the second horizontal element 44 in the first direction is an open end 44a.

In the antenna element 32 configured as described above, a path length from a contact portion with the feeding portion 31 to the open end 44a can be designed to receive radio waves of, for example, FM broadcast waves (76 MHz to 108 MHz), which fall within the predetermined frequency band. This path length is a total length of the first vertical element 41, the first horizontal element 42, the second vertical element 43, and the second horizontal element 44. When the path length of the antenna element 32 is defined as L, and when a wavelength of a center frequency of the predetermined frequency band in air (for example, FM broadcast waves) is defined as λ, and a wavelength shortening factor of the glass plate 10 is defined as k, it is preferable that the following relational expression (1) be satisfied.

$$0.50 \times ( 1 / 4 ) \times λ \times k \leq L \leq 2.0 \times ( 1 / 4 ) \times λ \times k \qquad ( 1 )$$

Also, it is more preferable that the path length L of the antenna element 32 satisfy the following expression (2):

$$0.75 \times ( 1 / 4 ) \times λ \times k \leq L \leq 1.5 \times ( 1 / 4 ) \times λ \times k \qquad ( 2 )$$

Therefore, radio waves in the predetermined frequency band can be received with a desired gain.

As described above, the vehicle window glass 1 of the present embodiment includes the glass plate 10, the antenna 30 provided on the glass plate 10 and capable of receiving radio waves in a predetermined frequency band, and the defogger 20 of an electric heating type provided on the glass plate 10. In a plan view with the glass plate 10 attached to the window frame 2, when a direction parallel to the horizontal plane is defined as a horizontal direction and a direction perpendicular to the horizontal direction is defined as a vertical direction, the antenna 30 includes the first antenna 30A provided on one side of the horizontal direction (first direction), and the second antenna 30B provided on the other side of the horizontal direction (second direction). Each of the first antenna 30A and the second antenna 30B includes the feeding portion 31, the first vertical element 41 that extends from the feeding portion 31 to one side in the vertical direction (the third direction) close to the defogger 20, the first horizontal element 42 that is close to the defogger 20 in the vertical direction and extends from the first vertical element 41 to a side in the horizontal direction in which the first antenna 30A and the second antenna 30B are close to each other, and the second vertical element 43 that extends from the first horizontal element 42 to the other side in the vertical direction (the fourth direction). The second vertical element 43 of the first antenna 30A and the second vertical element 43 of the second antenna 30B are close to each other in the horizontal direction.

According to this configuration, the first horizontal elements 42 of the first antenna 30A and the second antenna 30B are close to the defogger 20 and are capacitively coupled thereto. Also, the second vertical element 43 of the first antenna 30A and the second vertical element 43 of the second antenna 30B are close to each other and are capacitively coupled. Therefore, the vehicle window glass 1 can receive radio waves in the predetermined frequency band (for example, FM broadcast waves) with a desired gain, thereby achieving the improved transmission characteristic (S21) from the first antenna 30A to the second antenna 30B.

Specifically, in the present embodiment, the second vertical element 43 of the first antenna 30A and the second vertical element 43 of the second antenna 30B are close to each other in the horizontal direction with a spacing of 10 mm or less therebetween.

Also, in the present embodiment, the first horizontal element 42 and the defogger 20 are close to each other in the vertical direction with a spacing of 30 mm or less therebetween.

Furthermore, in the present embodiment, the antenna 30 is capable of receiving FM broadcast radio waves as radio waves in the predetermined frequency band.

### Second Embodiment

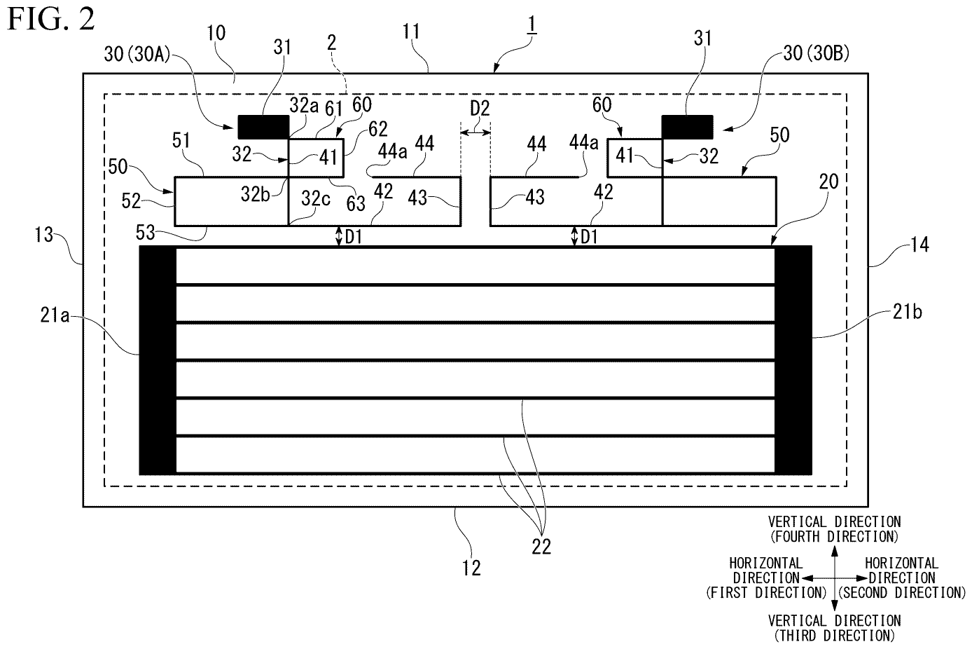

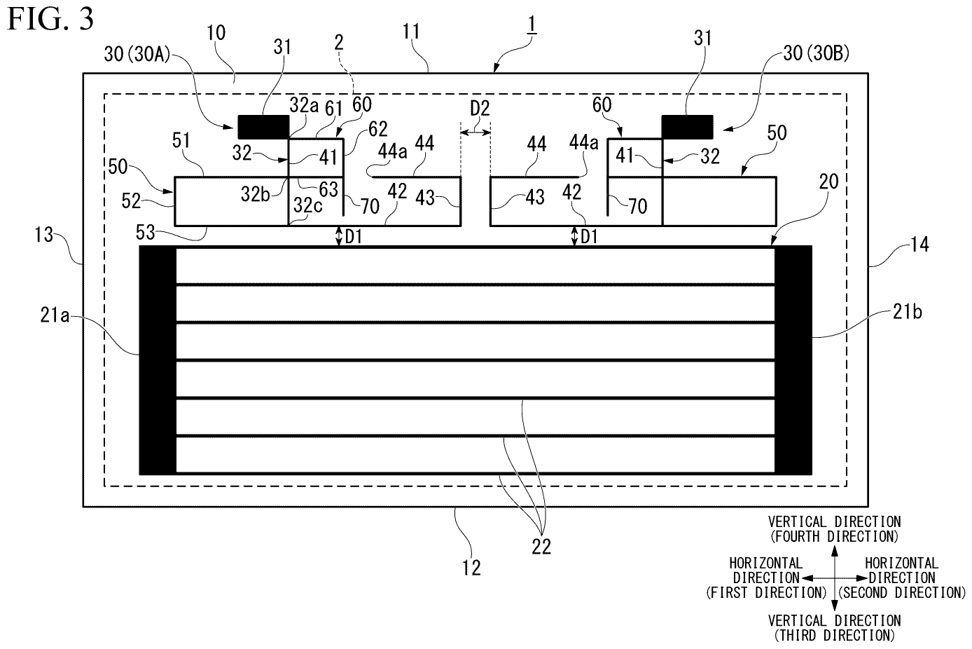

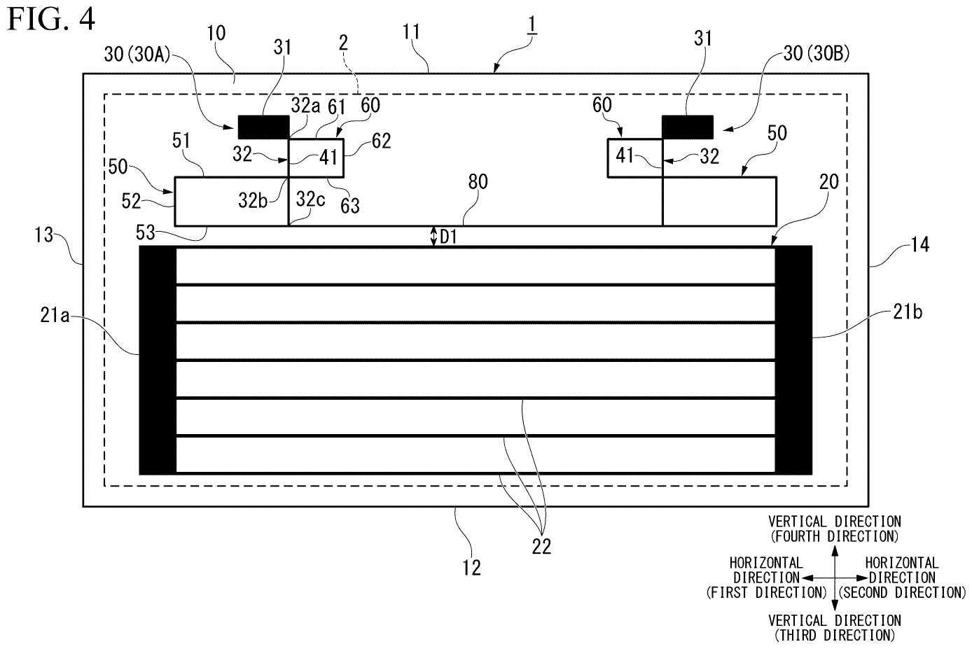

FIG. 2 is a plan view showing a vehicle window glass 1 according to a second embodiment of the present invention. Note that, in FIG. 2, components the same as those in the above-described embodiment will be denoted by the same reference signs, and description thereof will be simplified or omitted below. The same applies to FIGS. 3 and 4 to be described later.

As shown in FIG. 2, in the second embodiment, each of the first antenna 30A and the second antenna 30B includes a first loop element 50 that is connected to the first vertical element 41, has a loop shape, and is provided on a side in the horizontal direction in which the first antenna 30A and the second antenna 30B are away from the other.

As in the first embodiment, describing a configuration on the first antenna 30A side, an antenna element 32 includes a first contact portion 32a, a second contact portion 32b, and a third contact portion 32c. The first contact portion 32a is provided at an end part of the first vertical element 41 in the fourth direction. At the first contact portion 32a, the feeding portion 31 and the end part of the first vertical element 41 in the fourth direction are connected.

The second contact portion 32b is provided at an intermediate part of the first vertical element 41. The intermediate part of the first vertical element 41 may be any part excluding both end parts of the first vertical element 41, and preferably refers to a middle region obtained when the entire length of the first vertical element 41 is divided into three equal parts. At the second contact portion 32b, the first vertical element 41 and one end part of the first loop element 50 (first element 51) are connected.

The third contact portion 32c is provided at an end part of the first vertical element 41 in the third direction. At the third contact portion 32c, the first vertical element 41, the other end part of the first loop element 50 (third element 53), and a first horizontal element 42 are connected. The first loop element 50 and the first horizontal element 42 do not extend below the third contact portion 32c, thereby allowing performance to be achieved within a compact antenna area in the vertical direction.

The first loop element 50 is connected to the first vertical element 41 and has a loop shape. Here, the loop shape only needs to be formed as a closed loop, and may be formed not only with the same line width but also with a part having an increased line width. A shape of the first loop element 50 may be, for example, a circular shape such as a circle, a substantially circular shape, an ellipse, or a substantially ellipse, or a rectangular or polygonal shape such as a square, a substantially square shape, a rectangle, a substantially rectangular shape, a parallelogram, a substantially parallelogram, a diamond, or a substantially diamond shape.

The first loop element 50 shown in FIG. 2 includes the first element 51, a second element 52, and the third element 53. The first element 51 extends in the first direction from the first vertical element 41. The second element 52 extends in the third direction away from the feeding portion 31 from an end part of the first element 51 in the first direction. The third element 53 extends in the second direction from an end part in the third direction of the second element 52 and is connected to the first vertical element 41.

Specifically, the first element 51 is connected to the second contact portion 32b. The first element 51 has a linear conductor pattern extending in the first direction from the second contact portion 32b. The second element 52 is connected to the end part of the first element 51 in the first direction. The second element 52 has a linear conductor pattern that extends in the third direction from the end part of the first element 51 in the first direction.

The third element 53 is connected to the end part of the second element 52 in the third direction. The third element 53 has a linear conductor pattern extending in the second direction from the end part of the second element 52 in the third direction. An end part of the third element 53 in the second direction is connected to the third contact portion 32c. That is, the third element 53 is connected to the end part of the first vertical element 41 in the third direction.

In the antenna element 32, similarly to the shortest path length in the relational expressions (1) and (2) described above, a path length from the first contact portion 32a to an open end 44a when passing through the first loop element 50 is set to approximately (¼)×λ×k for a predetermined frequency, thereby making it possible for the antenna 30 to have a wide bandwidth with multiple resonance points. This path length is, for example, a total length of the first element 51, the second element 52, the third element 53, the first horizontal element 42, the second vertical element 43, and the second horizontal element 44 from the first contact portion 32a to the second contact portion 32b.

Furthermore, in the second embodiment, each of the first antenna 30A and the second antenna 30B is connected to the first vertical element 41 and has a loop shape.

Each of the first antenna 30A and the second antenna 30B includes a second loop element 60 that is provided on a side in the horizontal direction in which the first antenna 30A and the second antenna 30B are close to each other. Similarly to the shape of the first loop element 50, a shape of the second loop element 60 may be, for example, a circular shape such as a circle, a substantially circular shape, an ellipse, or a substantially ellipse, or a rectangular or polygonal shape such as a square, a substantially square shape, a rectangle, a substantially rectangular shape, a parallelogram, a substantially parallelogram, a diamond, or a substantially diamond shape.

The second loop element 60 is connected to the first vertical element 41 and has a loop shape. The second loop element 60 includes a fourth element 61, a fifth element 62, and a sixth element 63. The fourth element 61 extends in the second direction from the first vertical element 41. The fifth element 62 extends in the third direction from an end part of the fourth element 61 in the second direction. The sixth element 63 extends in the first direction from an end part of the fifth element 62 in the third direction and is connected to the first vertical element 41.

Specifically, the fourth element 61 is connected to the first contact portion 32a. The fourth element 61 has a linear conductor pattern that extends in the second direction from the first contact portion 32a. The fifth element 62 is connected to the end part of the fourth element 61 in the second direction. The fifth element 62 has a linear conductor pattern that extends in the third direction from an end part in the first direction of the fourth element 61.

The sixth element 63 is connected to the end part of the fifth element 62 in the third direction. The sixth element 63 has a linear conductor pattern that extends in the first direction from the end part of the fifth element 62 in the third direction. An end part of the sixth element 63 in the first direction is connected to the second contact portion 32b. According to the above-described configuration, variations in the path length of the antenna element 32 can be further increased by passing through the second loop element 60. Therefore, the antenna 30 can be made to have a wide bandwidth with multiple resonance points.

### Third Embodiment

FIG. 3 is a plan view showing a vehicle window glass 1 according to a third embodiment of the present invention.

As shown in FIG. 3, an antenna element 32 of the third embodiment includes an auxiliary element 70. The auxiliary element 70 has a linear conductor pattern that extends in the third direction from a corner portion at which a fifth element 62 and a sixth element 63 are connected. An end part of the auxiliary element 70 in the third direction is an open end.

According to this configuration, in the antenna element 32, a path length from a first contact portion 32a to the open end of the auxiliary element 70 can be set to a length that allows reception of radio waves in a second frequency band different from FM broadcast waves. This path length is a total length of a fourth element 61, the fifth element 62, and the auxiliary element 70. Note that, similarly to the first embodiment and the second embodiment described above, when the path length from the first contact portion 32a to the open end of the auxiliary element 70 is set to approximately (¼)×λ×k for a predetermined frequency, a wideband antenna 30 with multiple resonance points can be obtained.

### Fourth Embodiment

FIG. 4 is a plan view showing a vehicle window glass 1 according to a fourth embodiment of the present invention.

As shown in FIG. 4, in the fourth embodiment, first vertical elements 41 of a first antenna 30A and a second antenna 30B are close to a defogger 20 in the vertical direction. The first vertical elements 41 of the first antenna 30A and the second antenna 30B are connected to each other by a connection element 80 extending in the horizontal direction. In this manner, the first antenna 30A and the second antenna 30B may be directly connected by the connection element 80.

A spacing of dimension D1 is formed in the vertical direction between the connection element 80 and a defogger 20 (an uppermost heater wire 22). The dimension D1 is, for example, 100 mm or less. The dimension D1 is preferably 30 mm or less, may be 10 mm or less, or may be 5 mm or less. A lower limit of the dimension D1 is not particularly limited as long as it is greater than 0 mm. If a first horizontal element 42 and the defogger 20 are capacitively coupled, and a function as an improvement element for a transmission characteristic (S21) and a reflection characteristic (S11) in a predetermined frequency band can be obtained, the lower limit of the dimension D1 is set as appropriate.

Although the vehicle window glass according to the embodiments of the present invention has been described above, the present invention is not limited to the above-described embodiments, and can be freely changed within the scope of the present invention. For example, some or all of each embodiment may be implemented in combination.

### Examples

Effects of the present invention will become apparent by examples below. Note that, the present invention is not limited to the following examples. The present invention can be implemented with appropriate modifications within a range not changing the gist thereof.

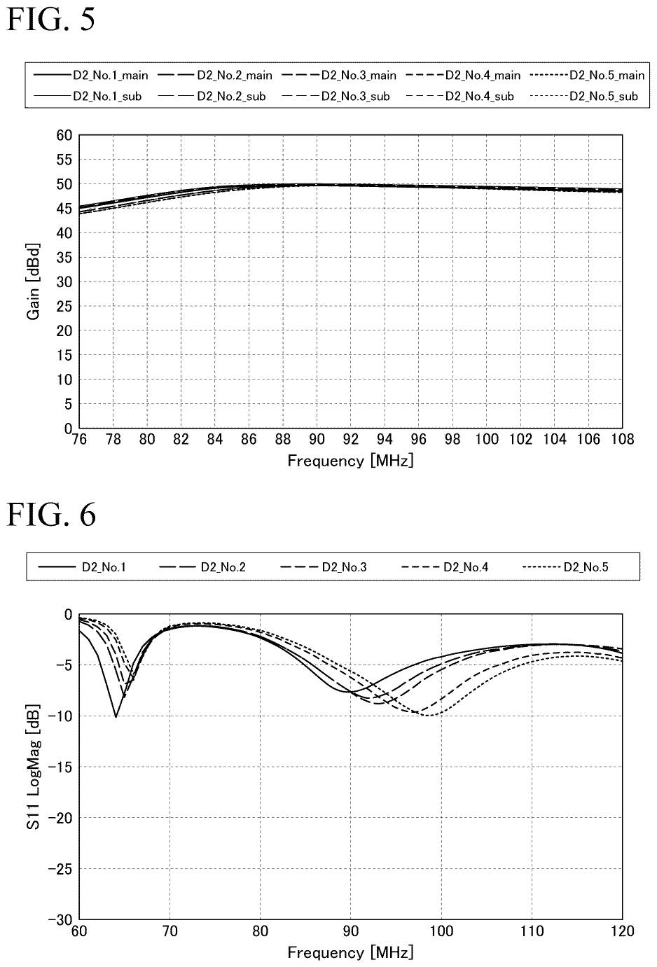

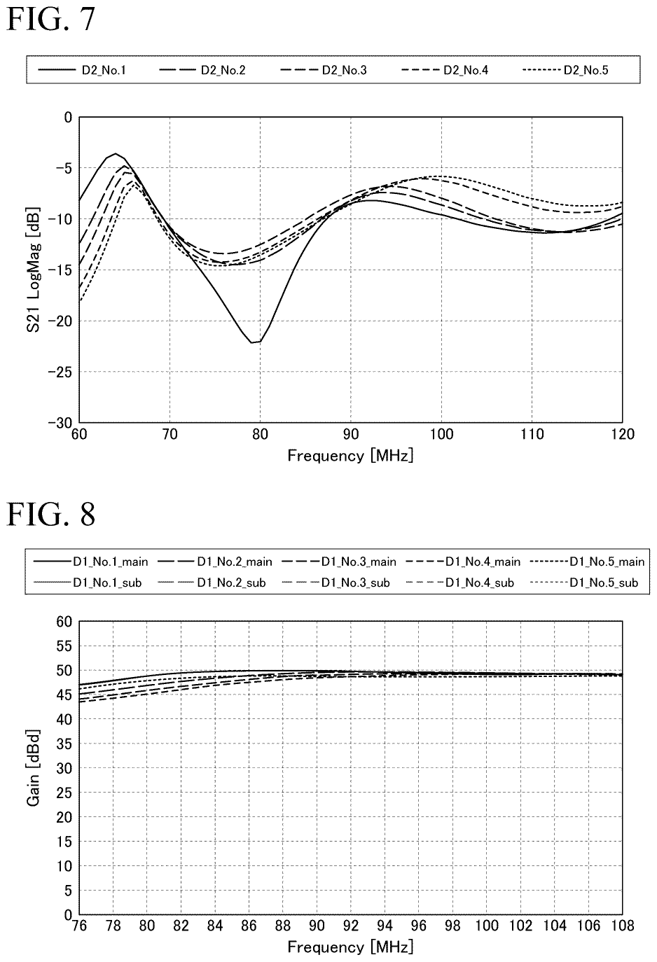

FIG. 5 is a graph showing measurement results of an antenna gain in a predetermined frequency band of a vehicle window glass 1 according to a first example of the present invention. FIG. 6 is a graph showing measurement results of the reflection characteristic (S11) in the predetermined frequency band of the vehicle window glass 1 according to the first example of the present invention. FIG. 7 is a graph showing measurement results of the transmission characteristic (S21) in the predetermined frequency band of the vehicle window glass 1 according to the first example of the present invention.

In FIGS. 5 to 7, the horizontal axis represents frequency [MHz]. In FIG. 5, the vertical axis represents gain [dBd], and in FIGS. 6 and 7, the vertical axis represents gain [dB]. Also, “main” refers to the first antenna 30A disposed on the left edge 13 side of the glass plate 10. “Sub” refers to the second antenna 30B disposed on the right edge 14 side of the glass plate 10. The same applies to FIGS. 8 to 10 to be described later.

The first example of FIGS. 5 to 7 shows measurement results of samples of the vehicle window glass 1 when the dimension D2 is varied in the configuration of the first embodiment described above. In FIGS. 5 to 7, “No. 1” refers to a sample in which the dimension D2 is set to 10 mm. “No. 2” refers to a sample in which the dimension D2 is set to 30 mm. “No. 3” refers to a sample in which the dimension D2 is set to 50 mm. “No. 4” refers to a sample in which the dimension D2 is set to 70 mm. “No. 5” refers to a sample in which the dimension D2 is set to 90 mm. Note that, even when the dimension D2 is varied, the path lengths of the antenna elements 32 in all samples are kept uniform.

Referring to FIG. 5, it was confirmed that, for all of the samples, the antenna gain (reception gain) is high in the frequency band of FM broadcast waves. Also, it was found that even if the dimension D2 is varied, there is no significant difference in the gain performance among the samples. On the other hand, referring to FIG. 7, it was confirmed that the transmission characteristic (S21) is significantly improved when the dimension D2 is 10 mm (No. 1). Referring to FIGS. 6 and 7, the reflection characteristic (S11) and the transmission characteristic (S21) are not inversely correlated in the vicinity of 79 MHz in the frequency band of FM broadcast waves. That is, as the dimension D2 decreases, the transmission characteristic (S21) becomes lower in the vicinity of 79 MHz, despite the reflection characteristic (S11) being high. From this, it was found that the transmission characteristic (S21) can be improved by bringing the second vertical element 43 of the first antenna 30A and the second vertical element 43 of the second antenna 30B close to each other.

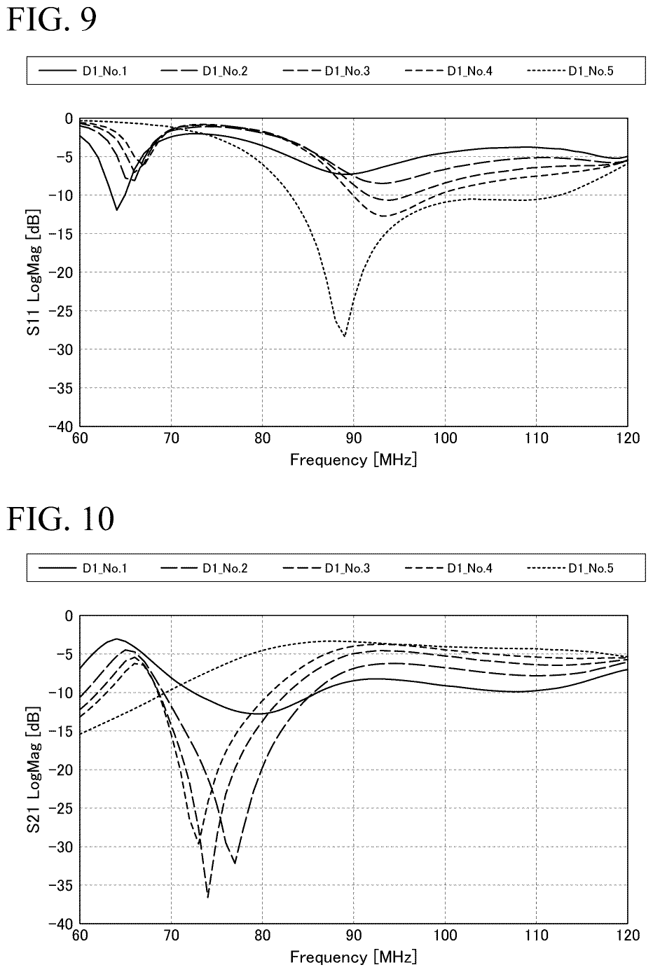

FIG. 8 is a graph showing measurement results of an antenna gain in a predetermined frequency band of a vehicle window glass 1 according to a second example of the present invention. FIG. 9 is a graph showing measurement results of the reflection characteristic (S11) in the predetermined frequency band of the vehicle window glass 1 according to the second example of the present invention. FIG. 10 is a graph showing measurement results of the transmission characteristic (S21) in the predetermined frequency band of the vehicle window glass 1 according to the second example of the present invention.

The second example of FIGS. 8 to 10 shows measurement results of samples of the vehicle window glass 1 when the dimension D1 is varied in the configuration of the third embodiment described above. In FIGS. 8 to 10, “No. 1” refers to a sample having the configuration shown in FIG. 3 (for example, D1=30 mm). “No. 2” refers to a sample in which the first heater wire 22 counted from an uppermost part of the defogger 20 shown in FIG. 3 is removed. “No. 3” refers to a sample in which the first and second heater wires 22 counted from the uppermost part of the defogger 20 shown in FIG. 3 are removed. “No. 4” refers to a sample in which the first to third heater wires 22 counted from the uppermost part of the defogger 20 shown in FIG. 3 are removed. “No. 5” refers to a sample in which all of the defogger 20 shown in FIG. 3 is removed.

Referring to FIG. 8, it was confirmed that, for all of the samples, the antenna gain (reception gain) is high in the frequency band of FM broadcast waves. Also, it was found that even when the dimension D1 is varied, that is, depending on whether the defogger 20 is present or absent, there is no significant difference in the gain performance among the samples. On the other hand, referring to FIGS. 9 and 10, it was found that, in the inverse correlation relationship between the reflection characteristic (S11) and the transmission characteristic (S21), a peak of the reflection characteristic (S11) becomes smaller and the transmission characteristic (S21) is significantly enhanced when the defogger 20 is present (No. 1 to No. 4) compared to a case without the defogger 20 (No. 5). Particularly, it was confirmed that, in the samples No. 1 to No. 3 in which the defogger 20 is present, the transmission characteristic (S21) in a range of 70 to 80 MHz can be significantly improved. This is considered to be due to an effect that, when the defogger 20 is present, a current around the second antenna 30B becomes weaker than when the defogger 20 is not present.

As described above, according to the above-described examples, it was possible to provide the vehicle window glass 1 capable of receiving FM broadcast radio waves with a desired gain, thereby achieving the improved transmission characteristic (S21) from the first antenna 30A to the second antenna 30B.

In addition, the components in the above-described embodiments can be appropriately replaced with well-known components within a range not departing from the meaning of the present invention.

For example, in the above-described embodiment, a configuration in which the second horizontal element 44 is connected to the second vertical element 43 has been described. The present invention is not limited to the embodiment. For example, when the end part of the second vertical element 43 is an open end and the path length to the open end of the second vertical element 43 of the antenna element 32 is set to a length that allows reception of radio waves in a predetermined frequency band, the second vertical element 43 may be omitted.

Also, for example, in the second to fourth embodiments, configurations including both the first loop element 50 and the second loop element 60 have been described. The present invention is not limited to such embodiments. A configuration including only one of the first loop element 50 and the second loop element 60 may be employed.

Also, for example, the numbers and ordinal numbers such as the first element to the sixth element and the first contact portion to the third contact portion described above are indicated for distinguishing the respective components. The numbers and ordinal numbers may be increased, decreased, or reassigned as appropriate depending on the purpose.

What is claimed is:

1. A vehicle window glass comprising:
a glass plate;
an antenna provided on the glass plate, the antenna being capable of receiving radio waves in a predetermined frequency band; and
an electric heating defogger provided on the glass plate, wherein
when a direction parallel to a horizontal plane is defined as a horizontal direction, and a direction perpendicular to the horizontal direction is defined as a vertical direction in a plan view in a state in which the glass plate is attached to a window frame,
the antenna includes:
a first antenna provided on one side in the horizontal direction; and
a second antenna provided on the other side in the horizontal direction,
each of the first antenna and the second antenna includes:
a feeding portion;
a first vertical element extending from the feeding portion to one side in the vertical direction close to the defogger;
a first horizontal element close to the defogger in the vertical direction, the first horizontal element extending from the first vertical element to a side in the horizontal direction in which the first antenna and the second antenna are close to each other; and
a second vertical element extending from the first horizontal element to the other side in the vertical direction, the second vertical element of the first antenna and the second vertical element of the second antenna being close to the other in the horizontal direction.

2. The vehicle window glass according to claim 1, wherein
the second vertical element of the first antenna and the second vertical element of the second antenna are close to each other in the horizontal direction with a spacing of 10 mm or less.

3. The vehicle window glass according to claim 1, wherein
the first horizontal element and the defogger are close to each other in the vertical direction with a spacing of 30 mm or less.

4. The vehicle window glass according to claim 1, wherein
each of the first antenna and the second antenna includes a first loop element,
the first loop element is connected to the first vertical element,
the first loop element has a loop shape, and
the first loop element is provided on a side in the horizontal direction in which the first antenna and the second antenna are away from the other.

5. The vehicle window glass according to claim 1, wherein
each of the first antenna and the second antenna includes a second loop element,
the second loop element is connected to the first vertical element,
the second loop element has a loop shape, and
the second loop element is provided on a side in the horizontal direction in which the first antenna and the second antenna are close to each other.

6. A vehicle window glass comprising:
a glass plate;
an antenna provided on the glass plate, the antenna being capable of receiving radio waves in a predetermined frequency band; and
an electric heating defogger provided on the glass plate, wherein
when a direction parallel to a horizontal plane is defined as a horizontal direction, and a direction perpendicular to the horizontal direction is defined as a vertical direction in a plan view in a state in which the glass plate is attached to a window frame,
the antenna includes:
a first antenna provided on one side in the horizontal direction; and
a second antenna provided on the other side in the horizontal direction,
each of the first antenna and the second antenna includes:
a feeding portion; and
a first vertical element extending from the feeding portion to one side in the vertical direction close to the defogger, and
the first vertical element of the first antenna and the first vertical element of the second antenna are connected to each other by a connection element,
the connection element is close to the defogger in the vertical direction, and
the connection element extends in the horizontal direction.

7. The vehicle window glass according to claim 6, wherein
the connection element and the defogger are close to each other in the vertical direction with a spacing of 30 mm or less.

8. The vehicle window glass according to claim 6, wherein
each of the first antenna and the second antenna includes a first loop element,
the first loop element is connected to the first vertical element,
the first loop element has a loop shape, and
the first loop element is provided on a side in the horizontal direction in which the first antenna and the second antenna are away from the other.

9. The vehicle window glass according to claim 6, wherein
each of the first antenna and the second antenna includes a second loop element,
the second loop element is connected to the first vertical element,
the second loop element has a loop shape, and
the second loop element is provided on a side in the horizontal direction in which the first antenna and the second antenna are close to each other.

10. The vehicle window glass according to claim 1, wherein
the antenna is capable of receiving FM broadcast radio waves as the radio waves in the predetermined frequency band.

11. The vehicle window glass according to claim 6, wherein
the antenna is capable of receiving FM broadcast radio waves as the radio waves in the predetermined frequency band.
